(19) United States
(12) Patent Application Publication
(10) Pub. No.: US 2025/0364647 A1
(43) Pub. Date: Nov. 27, 2025

(54) MANUFACTURING METHOD, ENERGY STORAGE ELEMENT AND LID ASSEMBLY

(71) Applicant: VARTA Microbattery GmbH, Ellwangen Jagst (DE)

(72) Inventors: Dominik Kieninger, Rainau (DE); Michael Geiger, Ellwangen (DE); Waldemar Frank, Ellwangen (DE); Verena Drews, Giengen (DE)

(21) Appl. No.: 19/292,979

(22) Filed: Aug. 7, 2025

Related U.S. Application Data
(63) Continuation-in-part of application No. PCT/EP2024/072349, filed on Aug. 7, 2024.

(30) Foreign Application Priority Data
Aug. 8, 2023 (EP) 23190399.8
Oct. 10, 2024 (EP) 24205942.6

(51) Int. Cl. H01M 50/169; H01M 10/0525; H01M 10/0587; H01M 50/107; H01M 50/152

(52) U.S. Cl. CPC H01M 50/169; H01M 10/0525; H01M 10/0587; H01M 50/107; H01M 50/152

(57) ABSTRACT

A method of manufacturing an energy storage element includes providing an electrode-separator assembly, applying a contact sheet metal member to a terminal end face of the electrode-separator assembly, and welding a bridging sheet metal member onto the contact sheet metal member or fixing a bridging sheet metal member to the contact sheet metal member by forming an alternative material-locking connection or a form-locking connection. The method additionally includes inserting the electrode-separator assembly into a housing part and closing the housing part by a lid to form a closed housing. The method further includes welding the lid to the contact sheet metal member or to the bridging sheet metal member. The lid has at least one hole which, when the lid is welded on, allows pressure equalization between the two sides of the lid.

### CROSS REFERENCE TO RELATED APPLICATIONS

This application is a continuation in part of International Patent Application No. PCT/EP2024/072349, filed on Aug. 7, 2024, which claims benefit to European Patent Application EP 23190399.8, filed on Aug. 8, 2023. The present application also claims benefit to European Patent Application No. EP 24205942.6, filed on Oct. 10, 2024. Each of the above applications is hereby incorporated by reference herein.

### FIELD

The present disclosure relates to a manufacturing method, an energy storage element, and a lid assembly.

### BACKGROUND

Electrochemical energy storage elements can convert stored chemical energy into electrical energy by virtue of a redox reaction. The simplest form of an electrochemical energy storage element is the electrochemical cell. It comprises a positive and a negative electrode, between which a separator is arranged. During discharge, electrons are released at the negative electrode as a result of an oxidation process. This results in an electron current that can be drawn off by an external electrical consumer, for which the electrochemical cell serves as an energy source. At the same time, an ion current corresponding to the electrode reaction occurs within the cell. This ion current crosses the separator and is enabled by an ion-conducting electrolyte. The separator thus prevents direct contact between the electrodes. At the same time, however, it enables electrical charge compensation between the electrodes.

If the discharge is reversible, that is to say if it is possible to reverse the conversion of chemical energy into electrical energy that occurred during discharge and to recharge the cell, the cell is said to be a secondary cell. The designation of the negative electrode as the anode and of the positive electrode as the cathode in secondary cells refers to the discharge function of the electrochemical cell.

An electrochemical energy storage element can comprise exactly one electrochemical energy storage cell. However, it can also comprise two or more cells, which are preferably connected electrically in series or electrically in parallel.

Secondary lithium-ion cells are used as energy storage elements in many applications today because they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which, in addition to electrochemically active components, also comprise electrochemically inactive components.

In principle, all materials that can absorb and release lithium ions are suitable as electrochemically active components (active materials) for secondary lithium-ion cells. For the negative electrode, carbon-based particles such as graphitic carbon are used for this purpose. Lithium cobalt oxide (LiCoO₂), lithium manganese oxide (LiMn₂O₄) lithium iron phosphate (LiFePO₄) or derivatives thereof can be used as active materials for the positive electrode. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. Current collectors are generally coated with thin layers of the respective active materials. The current collector for the negative electrode (anode current collector) can be made of copper or nickel, for example, and the current collector for the positive electrode (cathode current collector) can be made of aluminum, for example.

Furthermore, as electrochemically inactive components, the electrodes may comprise an electrode binder (e.g., polyvinylidene fluoride (PVDF) or another polymer, for example, carboxymethyl cellulose), conductivity-enhancing additives, and other additives. The electrode binder ensures the mechanical stability of the electrodes and often also the adhesion of the active material to the current collectors.

Lithium-ion cells usually comprise solutions of lithium salts such as lithium hexafluorophosphate (LiPF₆) in organic solvents (e.g., ethers and esters of carbonic acid) as electrolytes.

The composite electrodes are generally combined with one or more separators to form an electrode-separator assembly during the manufacture of a lithium-ion cell. The electrodes and separators are often, but not necessarily, bonded together under pressure, possibly by lamination or gluing. The basic functionality of the cell can then be established by impregnating the assembly with the electrolyte.

The electrode-separator assembly is typically formed in the form of a winding or processed into a winding. In the first case, for example, a ribbon-shaped positive electrode and a ribbon-shaped negative electrode as well as at least one ribbon-shaped separator are fed separately to a winding machine and wound in this machine into a winding with the sequence positive electrode/separator/negative electrode in a spiral shape. In the second case, a ribbon-shaped positive electrode and a ribbon-shaped negative electrode, as well as at least one ribbon-shaped separator, are first combined to form an electrode-separator assembly, for example using the aforementioned pressure. In a further step, the assembly is then wound.

For applications in the automotive sector, for e-bikes or for other applications with high energy requirements, such as in electric tools, lithium-ion cells with the highest possible energy density are required, which at the same time can be loaded with high currents during charging and discharging.

Cells for the aforementioned applications are often designed as cylindrical round cells, for example with a form factor of 21×70 (diameter*height in mm). Cells of this type always comprise an electrode-separator assembly in the form of a winding. Modern lithium-ion cells with this form factor can achieve an energy density of up to 270 Wh/kg.

Electrical contacting of the electrodes of an energy storage element poses a challenge. In round cells with a form factor of 21×70, for example, the electrodes of the winding must be electrically connected and linked to the electrical poles of the respective housing.

The classic solution here is the “tab design.” One end of a strip-shaped metal sheet (the “tab”) is welded to an electrode, and the other end is connected, for example, to a functional part of a CID (current interrupt device) that is integrated into a multi-part lid of a metal housing. An example of this is described in U.S. Pat. No. 7,432,010 B2.

The function of a CID is known to skilled persons; a CID ensures that the flow of current in an energy storage element is interrupted in the event of a malfunction. Another safety feature is the so-called PRV (pressure relief valve). This opens when a defined pressure limit is exceeded and prevents dangerous overpressure from building up in an energy storage element.

The tab design has several weaknesses. One problem is that the tab must be relatively long because it can only be welded to the inside of the lid before the housing is closed. And when the housing is closed, the tab must be folded at least once, which is often difficult to achieve in production. In addition, the folded tab takes up space inside the housing that is no longer available for electrochemical active material, and the tab itself is a bottleneck in terms of current flow into and out of the housing, but also in terms of heat dissipation. When an electrochemical cell is in operation, heat is generated in the electrodes, which must be dissipated. This is difficult when only a tab is available as a thermal bridge.

In recent years, there has been increased work on lithium-ion cells in which the electrodes are contacted by means of a so-called “tabless design.” This design completely dispenses with tabs. Instead, electrode-separator assemblies are manufactured in the form of a winding, in which the electrodes have metallic current collectors with uncoated longitudinal edges that protrude from the winding at the end faces. There, metallic contact sheet metal members can be welded onto the longitudinal edges, as described, for example, in WO 2017/215900 A1. This makes it possible to electrically contact the current collector and thus also the associated electrode over its entire length. This significantly reduces the internal resistance within the cells. As a result, large currents can be absorbed much better and heat can also be dissipated more effectively from the winding.

However, the “tabless design” in its known variants does not solve all existing problems. For example, an electrical connection between the lid and the contact sheet metal member to be contacted is still required. A suitable electrical conductor must be as long as the tab mentioned above, as it must be welded to the lid before the housing is closed. Consequently, the conductor must be folded like the tab when the housing is closed, creating a dead volume inside the housing.

### SUMMARY

In an embodiment, the present disclosure provides a method of manufacturing an energy storage element. The method includes providing an electrode-separator assembly with the sequence anode/separator/cathode, the electrode-separator assembly having a first terminal end face and a second terminal end face. The method further includes applying a contact sheet metal member to the first terminal end face or the second terminal end face, and welding a bridging sheet metal member onto the contact sheet metal member or fixing a bridging sheet metal member to the contact sheet metal member by forming an alternative material-locking connection or a form-locking connection. The method additionally includes inserting the electrode-separator assembly into a housing part having a circular opening, and closing the circular opening of the housing part by a lid to form a closed housing, wherein the lid has a first side which, after closing, faces the interior of the housing, and a second side which faces the exterior. Moreover, the method includes welding the lid to the contact sheet metal member or to the bridging sheet metal member. The lid has at least one hole which, when the lid is welded on, allows pressure equalization between the two sides of the lid.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a sectional view of a first embodiment of an energy storage cell with a lid assembly and a bridging sheet metal member;

FIG. 2 shows a sectional view of a second embodiment of an energy storage cell;

FIG. 3 shows a sectional view of a third embodiment of an energy storage cell;

FIG. 4 shows a partially sectioned view of the first embodiment of the energy storage cell;

FIG. 5 is a representation of a preferred embodiment of a lid assembly;

FIG. 6 is a representation of a preferred embodiment of a bridging sheet metal member suitable for an energy storage cell;

FIG. 7 is a representation of a preferred embodiment of a contact sheet metal member suitable for an energy storage cell;

FIG. 8 shows an electrode-separator assembly which may be part of an energy storage cell, and its components;

FIG. 9 is a view (cross-sectional representation) of the bottom region of an energy storage cell;

FIG. 10 shows a cross-sectional view of a fourth embodiment of an energy storage cell; and

FIG. 11 shows a sectional view of a fifth embodiment of an energy storage cell.

### DETAILED DESCRIPTION

The present disclosure provides energy storage elements which are characterized by a high energy density. At the same time, the energy storage elements to be provided should meet the highest safety standards.

A method according to the present disclosure is characterized by the following features:
a. Providing an electrode-separator assembly with the sequence anode/separator/cathode, which has a first terminal end face and a second terminal end face;
b. Applying a contact sheet metal member to one of the end faces;
c. In preferred embodiments,
welding a bridging sheet metal member onto the contact sheet metal member or
fixing a bridging sheet metal member on the contact sheet metal member by forming an alternative material-locking connection or a form-locking connection;
d. Inserting the electrode-separator assembly into a housing part which has a terminal circular opening, in particular into a metallic housing cup;
e. closing the circular opening of the housing part by means of a lid to form a closed housing, wherein the lid has a first side which, after closing, faces the interior of the housing, and a second side which faces the exterior; and
f. Welding the lid to the contact sheet metal member or to the bridging sheet metal member.

Step b. is preferably carried out before step d. However, it is also possible to apply the contact sheet metal member to one of the end faces of the electrode-separator assembly (the one facing the opening) after the electrode-separator assembly has been inserted into the housing cup. In both cases, it is preferable to form a connection between a current collector protruding from this end face and the contact sheet metal member after applying the contact sheet metal member. For example, welding by means of a laser can be used to form a material-locking connection.

In many cases, after the electrode separator has been inserted, one of the end faces of the electrode-separator assembly rests directly on the bottom of the housing part with the terminal circular opening. It may then be necessary to connect a current collector protruding from this end face to the housing bottom. This can be done by welding through the housing bottom using a laser. In other possible embodiments, a suitable contact sheet metal member is applied to this end face before step d., so that after insertion only this contact sheet metal member needs to be contacted with the housing cup or its bottom, for example via a welded connection. The welded connection between the contact sheet metal member and the bottom can be produced, for example, by resistance welding.

Step c. is necessary only in cases where the contact sheet metal member itself does not comprise a bridging region (embodiments of the contact sheet metal member with and without a bridging region are described below). Step c. can also be carried out before or after step d., i.e. the insertion of the electrode-separator assembly into the housing cup.

Conventional closure methods can be used to close the circular opening with the lid. Closure by flanging is preferred. In this process, the edge of the circular opening is bent radially inwards, while at the same time a seal arranged between the lid and the edge is compressed. The seal and the lid can be processed as a prefabricated lid component in which the seal is fitted onto the edge of the lid.

In many cases, the degree of compression of the seal is highest in the region between the indentation described below and the lid.

The closing the cell may also comprise height calibration, in which the lid is pressed towards the bottom of the housing cup. This can significantly reduce the height of the cell and thus also its internal volume.

The method is characterized in that
g. the lid has at least one hole.

The connection between the contact sheet metal member and the bridging sheet metal member can be realized, if necessary, for example by a material-locking connection, in particular by welding or bonding or a soldered connection. A riveted connection is also possible.

Bonding can be achieved by connecting the contact sheet metal member and the bridging sheet metal member using an adhesive with electrically conductive properties. Such adhesives are known, for example, from printed circuit board technology.

A soldered connection can be formed by melting solder and allowing it to solidify in contact with the contact sheet metal member and the bridging sheet metal member.

The riveted connection can be achieved, for example, by means of a blind rivet, in particular a blind sealing rivet, which is pushed through a hole in the contact sheet metal member and the bridging sheet metal member.

According to the present disclosure, the lid is connected either directly to the contact sheet metal member or to the bridging sheet metal member, which in turn is in contact with the contact sheet metal member. This is achieved by welding the lid as mentioned above.

If, during welding, a part of the lid is completely melted in a certain weld region, this can cause problems. When the housing is closed, pressure can build up inside the housing that differs from the external pressure, for example as a result of the reduction in internal volume during height calibration or, if the housing is already filled with an electrolyte, as a result of electrolyte evaporating or undergoing chemical reactions, for example due to the heat generated during welding. This can have a very negative effect on the welding process. In extreme cases, molten material of the lid can be ejected from the weld region due to excess pressure inside the housing.

The at least one hole solves these problems by allowing pressure equalization between the two sides of the lid when the lid is welded on. This is possible as long as the at least one hole is not closed. A hole with a maximum diameter of 2000 μm, preferably with a maximum diameter of 1000 μm, more preferably with a maximum diameter of 500 μm, more preferably with a maximum diameter of 250 μm, in particular with a maximum diameter of 100 μm, is generally sufficient. The hole is preferably produced by a punching process or pierced into the lid or into a subcomponent thereof. It is also possible to produce the hole with the help of a laser beam.

In certain embodiments it is preferred to introduce electrolyte into the housing after step d. above, but before step e. above.

It is preferred to close the at least one hole before the cell is put into operation. In any case, a liquid-tight closure of the housing must be ensured.

Preferably, the method is characterized by the following additional feature a.:
a. The at least one hole is closed when the lid is welded on.

Alternatively, the hole can be closed after welding, for example by means of an adhesive.

In further preferred embodiments, the method is characterized by at least one of the following additional features a. and b.:
a. The lid is welded on using a laser.
b. The at least one hole is closed by means of a laser, in particular by means of the laser which is used in step a.

Thus, it is preferred that the at least one hole is closed by means of the same laser that is used to weld the lid. For this purpose, for example, the edges of the hole and the region of the contact sheet metal member or the bridging sheet metal member lying thereunder can be melted by means of the laser. When the melt solidifies, a welded joint is formed between the lid and the contact sheet metal member or between the lid and the bridging sheet metal member. At the same time, the hole is closed.

In further preferred embodiments, the method is characterized by at least one of the following additional features a. to c.:
a. The closed housing encloses an interior space in which the electrode-separator assembly is arranged.
b. The lid comprises a metal disc with a circular edge, wherein the metal disc has an inner side which delimits the interior space.
c. The metal disc comprises the at least one hole.

Features a. to c. are preferably implemented in combination with each other.

In further preferred embodiments, the method is characterized by of the following additional features a. and b.:
a. The contact sheet metal member comprises a connecting region in which it is connected to the inner side of the metal disc.
b. The bridging sheet metal member comprises a connecting region in which it is connected to the inner side of the metal disc.

Features a. and b. are preferably implemented as alternatives to each other.

In further preferred embodiments, the method is characterized by at least one of the following additional features a. and b.:
a. The metal disc comprises a connecting region in which it is welded to the connecting region of the contact sheet metal member or to the connecting region of the bridging sheet metal member.
b. The connecting region comprises the at least one hole.

Preferably, the metal disc and the contact sheet metal member or the metal disc and the bridging sheet metal member are fused together in the connecting regions by welding.

As explained below, the design described here eliminates the need for a separate long electrical conductor to electrically connect the lid and the contact sheet metal member. The function of the conductor is performed either by the bridging sheet metal member or by the contact sheet metal member with the already mentioned bridging region. These bridge a gap between the lid and the electrode-separator assembly inside the housing.

In addition, the welded connection between the lid and the contact sheet metal member or the lid and the bridging sheet metal member can be formed after the housing has been closed, which has great advantages in terms of optimum utilization of the available housing volume.

In preferred embodiments, the lid always has the following features immediately below: a. to d.:
a. The lid is a lid assembly which, in addition to the metal disc, comprises a pole cap which is in electrical contact with the metal disc.
b. The pole cap rests directly on the metal disc.
c. The pole cap and the metal disc enclose an intermediate space.
d. The pole cap comprises at least one aperture through which the connecting region of the metal disc is accessible from outside the housing, in particular for a laser accessible from outside the housing.

The immediately preceding features a. to d. are preferred in combination.

In designs in which the lid is a lid assembly, the aperture in the pole cap ensures that the connecting region is accessible from the outside. This allows the welding to be carried out by means of a laser.

In embodiments in which the contact sheet metal member performs the function of bridging the distance between the lid and the electrode-separator assembly, the method is preferably characterized by at least one of the immediately following features a. to c.
a. The contact sheet metal member comprises a contact region, preferably a disc-shaped contact region, for example an annular disc-shaped contact region, to which the longitudinal edge of the anode current collector or the longitudinal edge of the is connected, in particular welded.
b. The contact region is disposed circumferentially around the bridging region, preferably enclosing the bridging region.
c. The bridging region protrudes from the plane of the contact region and extends to the connecting region of the contact sheet metal member, in which the contact sheet metal member is connected to the inner side of the metal disc.

The immediately preceding features a. and b. are preferably implemented in combination. The immediately preceding features a. to c. are preferred when implemented in combination.

In preferred embodiments, the contact sheet metal member thus comprises a contact region, a bridging region and a connecting region. The contact region preferably extends in a first plane and preferably lies flat on one of the end faces. The bridging region extends out of the plane of the contact region toward the connecting region. The connecting region preferably extends in a second plane and preferably lies flat on the inside of the metal disc. The plane of the connecting region is therefore preferably axially spaced from the plane of the contact region. It is preferred that the two planes are aligned parallel to one another. The contact sheet metal member thus preferably comprises two regions (the contact region and the connecting region) in different planes.

As already mentioned above, the contact region of the contact sheet metal member can be formed as an annular disc-shaped contact region. In other embodiments, the contact region may comprise individual contact segments which are arranged around the bridging region and/or are connected to one another via the connecting region. For example, the connecting region and the contact segments may be connected to one another via webs. These webs may form the bridging region. The contact segments may, for example, be ring segments.

In embodiments in which the bridging sheet metal member performs the function of bridging the distance between the lid and the electrode-separator assembly, the method is preferably characterized by at least one of the features a. to c. following immediately below:
a. The bridging sheet metal member comprises a contact region, in particular an annular disc-shaped contact region, which is connected to the contact sheet metal member in particular by the welding.
b. The contact region is arranged around the bridging region and, in preferred embodiments, surrounds the bridging region.
c. The bridging region protrudes from the plane of the contact region and extends to the connecting region of the bridging sheet metal member, in which the bridging sheet metal member is connected to the inner side of the metal disc.

Preferably, the immediately preceding features a. and b. are implemented in combination. Preferred are the immediately preceding features a. to c. implemented in combination.

In preferred embodiments, the bridging sheet metal member thus comprises a contact region, a bridging region and a connecting region. The contact region preferably extends in a first plane and preferably lies flat on the contact sheet metal member. The bridging region protrudes out of the plane of the contact region and extends to the connecting region. The connecting region preferably extends in a second plane and preferably lies flat on the inside of the metal disc. The plane of the connecting region is therefore preferably axially spaced from the plane of the contact region. It is preferred that the two planes are aligned parallel to each other. The bridging sheet metal member thus preferably comprises two regions (the contact region and the connecting region) in different planes.

In addition to a ring-disc shape, the contact region of the bridging sheet metal member may also have other configurations. For example, it may be ring-shaped while having a polygonal outer contour, such as an outer edge with six or eight corners. In other embodiments, the contact region—similar to the case of the contact sheet metal member—may comprise individual contact segments that are arranged around the bridging region and/or are interconnected via the connecting region.

It should be mentioned at this point that, in principle, the metal disc of the lid can also perform the task of bridging the distance between the lid and the contact sheet metal member. For this purpose, it is necessary for the metal disc to comprise a bridging region which is connected to the contact sheet metal member in a connecting region, preferably by welding or bonding. This bridging region then protrudes in the axial direction, preferably extends to a contact sheet metal member which rests on one of the end faces.

Preferably, several safety functions are integrated into the lid of the energy storage element:
a. The metal disc of the lid is preferably configured as a PRV (pressure relief valve) and comprises an elongated weakening groove for this purpose.
b. In the connecting region, the metal disc is characterised by a lower material thickness than in the region surrounding the connecting region.

The immediately preceding features a. and b. are preferred in combination. However, they can also be implemented independently of each other.

The immediately preceding feature b. is relevant in connection with a CID function of the lid, which will be explained below with reference to the drawings.

Preferably, the elongated weakening groove runs circumferentially around the center of the metal disc.

In any case, it should be noted that the energy storage elements produced according to the method are preferably energy storage elements that have both PRV and CID functionality.

In a further preferred embodiment, the method is characterized by the following additional feature a.:
a. After step e. of claim 1, a formation of energy storage element (100) is carried out.

As explained above, step e. refers to the closing of the circular opening of the housing part by means of a lid to form a closed housing. As will be explained in the detailed description of the examples below, the present disclosure allows formation of the energy storage element with its housing already closed by the lid.

All energy storage elements that can be produced according to the method described above are the subject of the present disclosure. Preferably, an energy storage element is characterized by the following features:
a. The energy storage element comprises an electrode-separator assembly with the sequence anode/separator/cathode,
b. the electrode-separator assembly is in the form of a cylindrical winding with a first terminal end face and a second terminal end face and a winding shell between them,
c. the anode of the electrode-separator assembly comprises an anode current collector which has a first longitudinal edge and a second longitudinal edge parallel thereto and a main region which is loaded with a layer of negative electrode material, as well as a free edge strip which extends along its first longitudinal edge and which is not loaded with the negative electrode material,
d. the cathode of the electrode-separator assembly comprises a cathode current collector having a first longitudinal edge and a second longitudinal edge parallel thereto and a main region loaded with a layer of positive electrode material, and a free edge strip extending along its first longitudinal edge and not loaded with the electrode material,
e. the anode and the cathode are arranged within the electrode-separator assembly such that the first longitudinal edge of the anode current collector protrudes from the first end face and the first longitudinal edge of the cathode current collector protrudes from the second end face of the electrode-separator assembly,

f. the energy storage element comprises a contact sheet metal member which rests on the first longitudinal edge of the anode current collector and covers the first terminal end face or rests on the first longitudinal edge of the cathode current collector and covers the second terminal end face and is connected thereto,
g. the energy storage element comprises an airtight and liquid-tight housing which comprises a metallic housing part with a terminal circular opening, in particular a metallic housing cup with a terminal circular opening, and a lid with a circular edge which closes the circular opening, and which encloses an interior space in which the electrode-separator assembly is arranged,
h. the lid comprises a metal disc with a circular edge, wherein the metal disc has an inner side which delimits the interior space and an opposite outer side,

i. either the contact sheet metal member comprises a bridging region which is connected in a connecting region to the inner side of the metal disc, or a bridging sheet metal member is welded onto the contact sheet metal member, the bridging sheet metal member comprising a bridging region which is connected in a connecting region to the inner side of the metal disc.

j. The metal disc comprises a connecting region in which it is welded to the connecting region of the bridging sheet metal member or to the connecting region of the contact sheet metal member.
k. In its connecting region, the metal disc has a hole or at least a depression or a reduction in thickness in the region of the weld.

Many features of the energy storage element have already been referred to in the description of the method. Reference is hereby made to the corresponding explanations.

The electrochemical energy storage element is preferably an electrochemical energy storage cell.

As already explained above, it is possible that during welding the edges of the hole which allows pressure equalization and the underlying connecting region of the contact sheet metal member or of the bridging sheet metal member are melted by the laser. Depending on the welding parameters and/or on the size of the hole, it is possible that only the edges of the hole fuse with the underlying connecting region of the contact sheet metal member or of the bridging sheet metal member and that the hole itself is not filled with melt. In this case, a depression remains after the melt has solidified, on the outside of the metal disc. If, on the other hand, melt from the edges closes the hole, this generally results in a reduction in thickness in the fusion area.

It may be preferred, to fill the depression on the outside of the metal disc with a sealant, for example an adhesive, to ensure a reliable liquid and gastight closure, This is easily possible via appropriately designed openings in the lid, for example via the aperture in the pole cap of the lid described below. Alternatively, the welding may also be carried out directly by means of fusion welding with filler metal. In this case, a depression resulting from the hole can be filled with the filler metal. This can likewise be a preferred approach to ensure the liquid and gas tightness of the cell.

In some preferred embodiments, the connecting region of the bridging sheet metal member or the connecting region of the contact sheet metal member is connected to the connecting region of the metal disc by a weld in the form of a weld seam surrounding the hole, in particular by a circular weld seam. In this case, the hole itself can still be present after welding. In some preferred embodiments it can be preferred to additionally close the hole by filling it with the above mentioned adhesive. Also the combination of the circular weld seam surrounding the hole and the adhesive filling ensures liquid and gastight closure.

With regard to the mechanical stability of the energy storage element to be manufactured and the aforementioned safety functions, the following preferred features are also important:
a. The housing comprises a seal made of a plastic material which is fitted on the edge of the lid and is arranged between the lid and the housing part with the terminal circular opening, wherein the seal is preferably an annular seal.
b. A support ring made of a plastic material is arranged between the metal disc and the bridging sheet metal member or between the metal disc and the contact sheet metal member, in particular clamped.
c. The support ring rests on the contact region of the contact sheet metal member or the contact region of the bridging sheet metal member.
d. The support ring is part of the seal.

The immediately preceding features a. to c. are preferred, and in some preferred embodiments, features a. to d. are also realized in combination.

In preferred embodiments, the energy storage element is further characterized by the following features a. and b.:
a. The housing part with the terminal circular opening comprises, in axial sequence, a bottom, a central section and a closure section, wherein
   the central section is cylindrical and, in the central section, the winding shell of the electrode-separator assembly is in contact with the inner side of the housing part with the terminal circular opening, and
   in the closure section, the seal is in press contact with the edge of the lid and with the inner side of the housing part with the terminal circular opening, and
b. the housing part with the terminal circular opening has, in the closure section, an opening edge defining the circular opening, which is bent radially inwards over the edge of the lid on which the seal is fitted, and which fixes the lid, including the seal, in a form-locking manner in the circular opening of the housing part.

The electrode-separator assembly is preferably in direct contact with the inner side of the housing part with the terminal circular opening. It is preferred to lie directly against the inner side. In some embodiments, however, it may be provided to electrically insulate the inner side, for example by means of a foil. In this case, the electrode-separator assembly is in contact with the inner wall via the foil.

The bottom of the housing part with the terminal circular opening has preferably a circular shape. The housing part is usually formed by deep drawing. However, it is also possible to form the housing part by welding a bottom with a circular shape into a tubular half-part.

The energy storage element is preferably designed as a cylindrical round cell. Its height is preferably in the range from 50 mm to 150 mm. Its diameter is preferably in the range from 15 mm to 60 mm. Cylindrical round cells with these form factors are suitable, for example, for supplying power to electric drives in motor vehicles.

### Preferred Electrochemical Embodiments

In a preferred embodiment, the energy storage element is based on lithium-ion technology.

Basically, all electrode materials known for secondary lithium-ion cells can be used for the electrodes of the energy storage element.

The nominal capacity of the energy storage element, which is designed as a cylindrical round cell based on lithium-ion technology, preferably amounts to up to 15,000 mAh. With the form factor of 21×70, the round cell in one embodiment as a lithium-ion cell preferably has a nominal capacity in the range of 1,500 mAh to 7,000 mAh, preferably in the range of 3,000 to 5,500 mAh. With the form factor of 18×65, the round cell in one embodiment as a lithium-ion cell preferably has a nominal capacity in the range of 1,000 mAh to 5,000 mAh, preferably in the range of 2,000 to 4,000 mAh.

In further embodiments, the energy storage element may also be a sodium-ion cell, a potassium-ion cell, a calcium-ion cell, a magnesium-ion cell or an aluminium-ion cell. Among these variants, energy storage elements with sodium-ion cell chemistry are preferred.

In an energy storage element based on sodium-ion technology, it is preferred that both the anode and the cathode current collector consist of aluminum or an aluminum alloy. The housing and the contact sheet metal member and, if applicable, the bridging sheet metal member, may also consist of aluminum or an aluminum alloy.

### Preferred Design of the Housing

The energy storage element is preferred by having at least one of the following features a. to c.:
a. The central section and the closure section are separated by an indentation which circumferentially surrounds the outer side of the housing part with the terminal circular opening.
b. The housing part with the terminal circular opening has an identical maximum outer diameter in the central section and the closure section.
c. In the region of the indentation, the outer diameter of the housing part with the terminal circular opening is reduced, preferably by 4 to 20 times the wall thickness of the housing part with the terminal circular opening in this region.

It is preferred that at least the immediately preceding features a. and b. are realized in combination. All three immediately preceding features a. to c. are preferred if realized in combination.

Preferably, the annular seal is compressed in the closure section. It is preferably pressed radially against the circular edge of the lid.

A lid assembly is preferably characterized by the following features a. to g.:
a. The lid assembly comprises a metal disc and a pole cap which are in electrical and direct mechanical contact with each other.
b. The pole cap rests directly on the metal disc.
c. The pole cap and the metal disc enclose an intermediate space.
d. The metal disc comprises the connecting region described above, in which it can be welded to the connecting region of the contact sheet metal member or to the connecting region of the bridging sheet metal member.
e. The pole cap comprises at least one aperture through which the connecting region is accessible from outside the housing, in particular for a laser from outside the housing.
f. The lid assembly comprises a seal that is fitted onto its edge.
g. The connecting region comprises at least one hole.

Some parts of the lid assembly have already been explained in the description of the method. Reference is hereby made to these explanations.

The at least one hole is or comprises preferably a hole with a minimum diameter of 0.01 mm and a maximum diameter of 1 mm.

### Preferred Embodiments of the Contact Sheet Metal Member and the Bridging Sheet Metal Member

The contact sheet metal member can be electrically connected either to the anode current collector or to the cathode current collector.

In a preferred embodiment, a contact sheet metal member electrically connected to the anode current collector is characterized by at least one of the following features a. and b.:
a. The contact sheet metal member consists of nickel or copper or titanium or a nickel or copper or titanium alloy or stainless steel, for example of type 1.4303 or 1.4404 or of type SUS304, or of nickel-plated copper.
b. The contact sheet metal member consists of the same material as the anode current collector.

In a further preferred embodiment, a contact sheet metal member electrically connected to the cathode current collector is characterized by at least one of the following features a. and b.:
a. The contact sheet metal member consists of aluminum or an aluminum alloy.
b. The contact sheet metal member consists of the same material as the anode current collector.

The bridging sheet metal member preferably consists of the same material as the contact sheet metal member to which it is welded.

The contact sheet metal member connected to the anode current collector and/or the contact sheet metal member electrically connected to the cathode current collector are preferred if they have at least one of the following features a. and b.:
a. The contact sheet metal member has a preferably uniform thickness in the range from 50 μm to 600 μm, preferably in the range from 150 μm to 350 μm.

b. The contact sheet metal member is dimensioned such that it covers at least 40%, preferably at least 70%, preferably at least 80% of the first terminal or the second terminal end face on which it rests.

It is preferred that the immediately preceding features a. and b. are realized in combination with each other.

The bridging sheet metal member preferably consists of a sheet with a thickness in a range from 50 μm to 1 mm.

Covering as large an area of the end face as possible is important for the thermal management of the energy storage element. The larger the coverage, the easier it is to contact as long sections as possible of the first longitudinal edge of the respective current collector. Heat formed in the electrode-separator assembly can thus be dissipated well via the contact sheet metal member.

In some embodiments, it has proven advantageous to subject the longitudinal edge of the current collector to pretreatment before the contact sheet metal member is placed on it.

The longitudinal edge of the current collector may also have been subjected to a directed deformation by means of the pretreatment. For example, it may be bent in a defined direction. Furthermore, the longitudinal edge of the current collector may also be deformed in an undirected manner, for example as a result of pressure contact with the contact sheet metal member.

### Preferred Design of Current Collectors and Separators

The anode current collector, the cathode current collector and the separator or separators of the cell preferably have the following dimensions:
A length in the range from 0.5 m to 25 m
A width in the range from 40 mm to 145 mm

In the electrode-separator assembly, the ribbon-shaped anode, the ribbon-shaped cathode and the ribbon-shaped separator or separators are preferably wound in a spiral. To produce the electrode-separator assembly, the ribbon-shaped electrodes and the ribbon-shaped separator(s) are generally fed into a winding device and preferably wound in a spiral around a winding axis. Bonding of the electrodes and the separators or contacting at elevated temperatures is usually not necessary. In some embodiments, the electrodes and the separator or separators are wound onto a cylindrical or hollow cylindrical winding core which rests on a winding mandrel and remains in the winding after winding.

The winding shell can be formed, for example, by a plastic film or an adhesive tape. It is also possible for the winding shell to be formed by one or more separator windings.

The current collectors of the energy storage element have the function of electrically contacting the electrochemically active components contained in the respective electrode material over as large an area as possible. The current collectors preferably consist of a metal or are at least metallized on the surface.

In the case of an energy storage element configured as a lithium-ion cell, suitable metals for the anode current collector are, for example, copper or nickel or other electrically conductive materials, in particular copper and nickel alloys or nickel-coated metals.

In the case of an energy storage element designed as a lithium-ion cell, aluminum or other electrically conductive materials, including aluminum alloys, are suitable as metals for the cathode current collector.

The anode current collector and/or the cathode current collector is preferably a ribbon-shaped metal foil with a thickness in the range from 4 μm to 30 μm.

In addition to foils, however, other ribbon-shaped substrates such as metallic or metallized nonwovens or open-pored metallic foams or expanded metals can also be used as current collectors.

The current collectors are preferably loaded with the respective electrode material on both sides.

It is preferred that the longitudinal edges of the separator or separators form the end faces of the electrode-separator assembly formed as a winding.

### Possible Designs of the Seal

It is preferred that the energy storage element is characterized by at least one of the following features a. and b.
a. The seal consists of a plastic material which has a melting point >200° C., preferably >300° C., preferably a melting point >300° C. and <350° C.
b. The plastic material is a polyetheretherketone (PEEK), a polyimide (PI), a polyphenylene sulfide (PPS) or a polytetrafluoroethylene (PTFE) or a polybutylene terephthalate (PBT) or ethylene-propylene-diene rubber (EPDM).

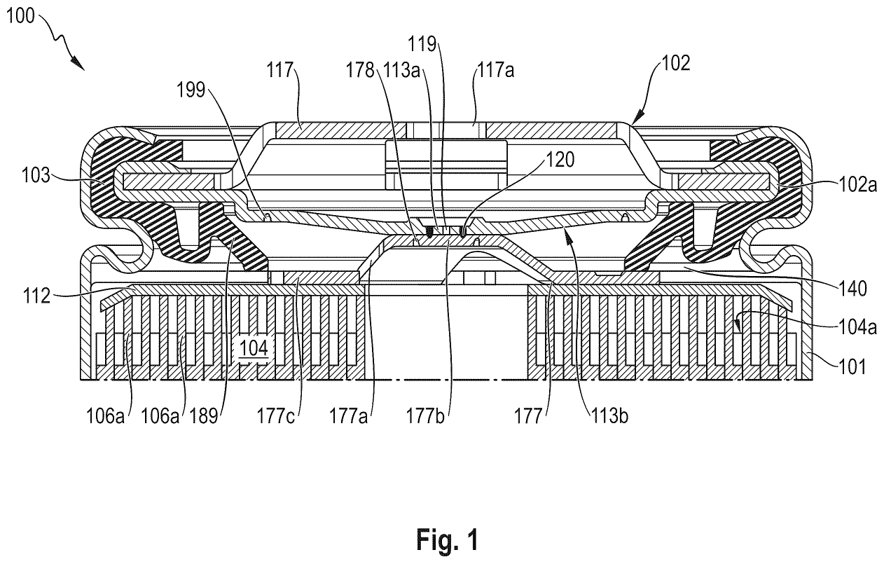

It is preferred that the immediately preceding features a. and b. are realized in combination.
The energy storage cell 100 shown in FIG. 1 comprises the electrode-separator assembly 104, which is in the form of a cylindrical winding with two terminal end faces and a winding shell lying between them. The first longitudinal edge 106a of the anode current collector 106 protrudes from the terminal end face 104a. This edge is not free from electrode material and is connected by welding to the contact sheet metal member 112, which rests on the longitudinal edge 106a and covers the first terminal end face 104a.

Furthermore, the energy storage cell 100 comprises an airtight and liquid-tight housing which comprises the metallic housing cup 101 with a terminal circular opening and the lid assembly 102 with a circular edge 102a which closes the circular opening. The lid assembly 102 comprises the metal disc 113, the bottom side 113b of which also corresponds to the first side 102b of the lid 102, which delimits the interior space 140 of the housing, and the pole cap 117, which rests directly on the metal disc 113 and is in electrical contact with it and encloses an intermediate space with it. The second side 102c of the lid 102 corresponds to the outer side of the pole cap 117 and faces outward.

The bridging sheet metal member 177 is welded onto the contact sheet metal member 112. The bridging sheet metal member 177 comprises the contact region 177c, the bridging region 177a and the connecting region 177b.

The contact region 177c extends in a first plane, lies flat on the contact sheet metal member 112 and is preferably fixed thereto by welding. The contact region 177c is formed as annular disc-shaped contact region and surrounds the bridging region 177a.

The bridging region 177a rises dome-like out of the plane of the contact region 177c and extends in the axial direction up to the connecting region 177b. The connecting region 177b extends in a second plane spaced apart from the first plane, is formed flat on its top side and lies flat against the bottom side 113b of the metal disc 113. The plane of the connecting region 177b is thus axially spaced from the plane of the contact region 177c. In the present embodiment, the two planes are aligned parallel to each other. The bridging sheet metal member 177 thus comprises two regions (the contact region 177c and the connecting region 113a) in different planes.

The connecting region 177b is bounded by the annular groove 178. The connecting region 177b is connected to the connecting region 113a of the metal disc 113 by a circular weld seam 120. However, instead of the circular weld seam 120, a spot weld connection would also be conceivable, in particular a weld connection via several spot welds.

The metal disc 113 comprises in its center the connecting region 113a, in which the circular weld with the connecting region 177b is realized. The metal disc 113 is formed as a PRV (pressure relief valve) and comprises the circular, elongated weakening groove 199 for this purpose. In the center of the connecting region 113a there is again the hole 119, which is circumferentially surrounded by the weld seam 120. In some cases, it may be advantageous to additionally seal the hole 119 with an adhesive.

The pole cap 117 comprises several apertures, including the hole 117a, through which the connecting region 113a is accessible for a laser from outside the housing.

The housing further comprises the plastic seal 103, which is fitted on the edge 102a of the lid assembly 102 and electrically insulates the metallic components of the lid assembly 102 from the housing cup 101. At the same time, it helps to seal the housing.

The energy storage cell 100 further comprises a support ring 189 which is clamped between the metal disc 113 and the bridging sheet metal member 177. The support ring 189 rests on the contact region 177c of the bridging sheet metal member 177 and presses against the metal disc 113 from below. In the present embodiment, the support ring 189 is part of the seal 103.

This embodiment of the energy storage cell 100 has various advantages:
The lid assembly 102 consists of only three parts, namely (from the outside to the inside) the pole cap 117, the metal disc 113 and the seal 103. Conventional lid assemblies with a comparable function generally comprise at least four parts. In contrast, the design of the lid assembly 102 is simplified.
The bridging sheet metal member 177 replaces the “tabs” mentioned at the outset.

The resulting simplified structure makes it possible to weld the bridging sheet metal member 177 to the metal disc 113 after the housing has been closed. All that is required is the hole 117a in the pole cap 117, as shown in the drawing. The welding can be carried out from the outside using a laser.
Welding is facilitated by hole 119, which allows pressure equalization between the interior space of the housing and the housing environment. As long as the connecting regions 113a and 177b are not connected to each other by the circular weld seam 120, they do not seal the cell airtight when hole 119 is present (The contact between the two flat connecting regions 113a and 177b still permits sufficient gas passage due to microscopic irregularities, such as surface or shape deviations of the components), so that pressure equalization is possible until the weld seam is completed.

Incidentally, this can also be used advantageously in other ways. As skilled persons know, electrochemical cells must undergo a so-called formation process before they are used for the first time. This refers to the process of initially charging and discharging the cell in order to bring about the electrochemical activation of the cell components. This process often results in cell gassing, for example as a result of electrolyte decomposition. Formation is therefore often carried out before the cell is actually closed, because otherwise critical pressures would build up in the cell. The hole 119 now makes it possible to carry out the formation of the cell even when the housing is already closed with the lid assembly 102. If gases are produced, pressure equalisation can take place at any time via the hole 119. After formation, the cell can then be sealed gas-tight, for example by closing the hole 119 during the welding processes described, or by forming the weld seam described surrounding the hole 119, with optional additional application of the above-mentioned adhesive to seal the hole 119.

Incidentally, the welded connection between the connecting regions 113a and 177b does not necessarily have to be formed as a circular line. It is also possible to melt the edges of the hole 119 and the connecting region 177b over a larger area.

The energy storage cell 100 is characterized by two safety functions, a PRV (pressure relief valve) and the aforementioned CID. The PRV is realized by the groove 199. When the pressure inside the housing exceeds a predefined limit value, the metal disc 113 ruptures along the groove 199.
The circular groove 178, which surrounds the center of the connection region 177b, ensures the CID function. When the pressure inside the housing increases, the metal disc 113 bulges outward. Due to the welded connection between the metal disc 113 and the bridging sheet metal member 177 in the connecting region 177b, the bulging membrane exerts a tensile force on the connecting region 177b. If this force becomes sufficiently strong, the connecting region 177b is torn out of the bridging sheet metal member 177 along the groove 178. As a result, the direct contact and electrical connection between the metal disc 113 and the bridging sheet metal member 177 are interrupted. An opening remains in the upper portion of the bridging sheet metal member 177.

Another important aspect: there is a risk that the tensile force mentioned above could lift the entire bridging sheet metal member 177 together with the metal disc 113, causing the CID to malfunction. To avoid such a situation, the seal may comprise the support ring 189. If the metal disc 113 bulges outwards, the support ring holds the bridging sheet metal member 177 in place and ensures that the CID functions.

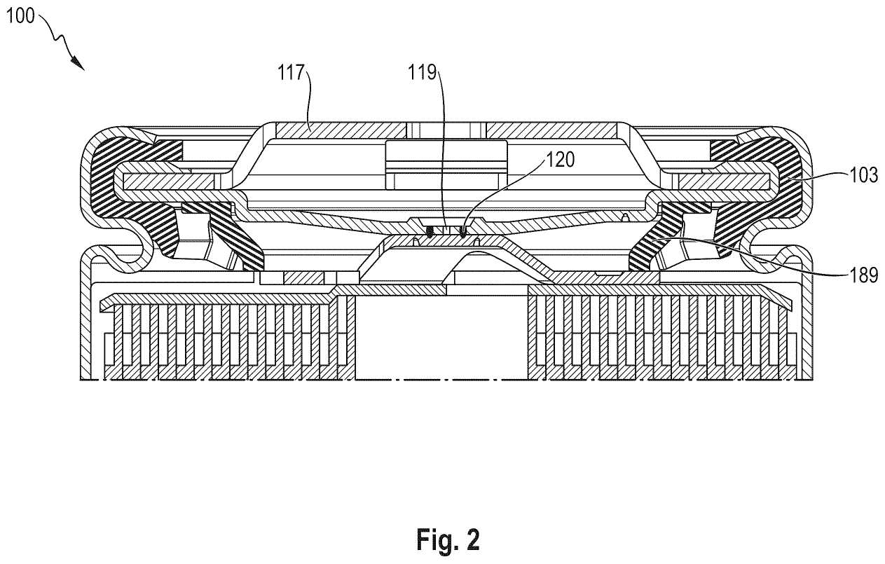

The energy storage cell 100 shown in FIG. 2 differs from that shown in FIG. 1 only in that the support ring 189 is not formed as part of the seal 102.

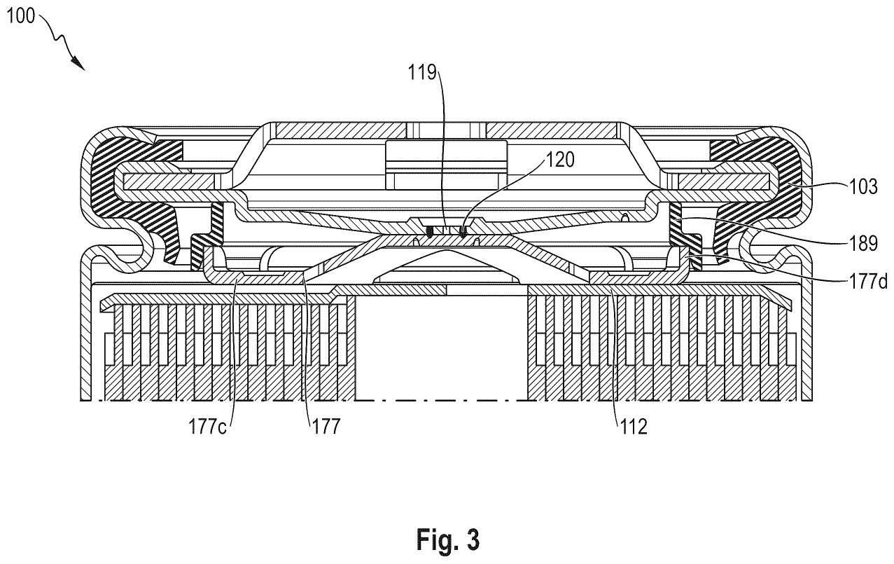

The energy storage cell 100 shown in FIG. 3 differs from that shown in FIG. 1 in that the support ring 189 is not formed as part of the seal 102. A further difference is that the edge 177d of the contact region 177c is bent upwards by 90°.

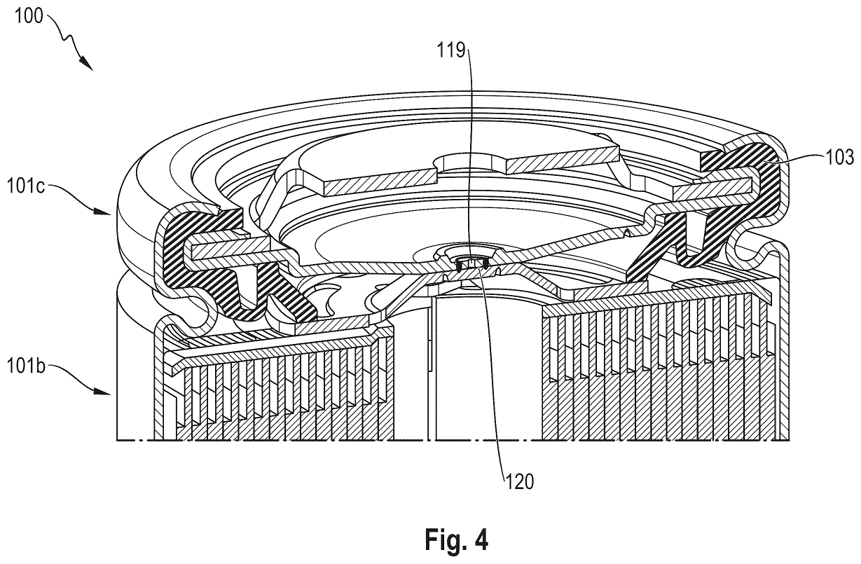

FIG. 4 is a partially sectional view of the embodiment of the energy storage cell shown in FIG. 1.

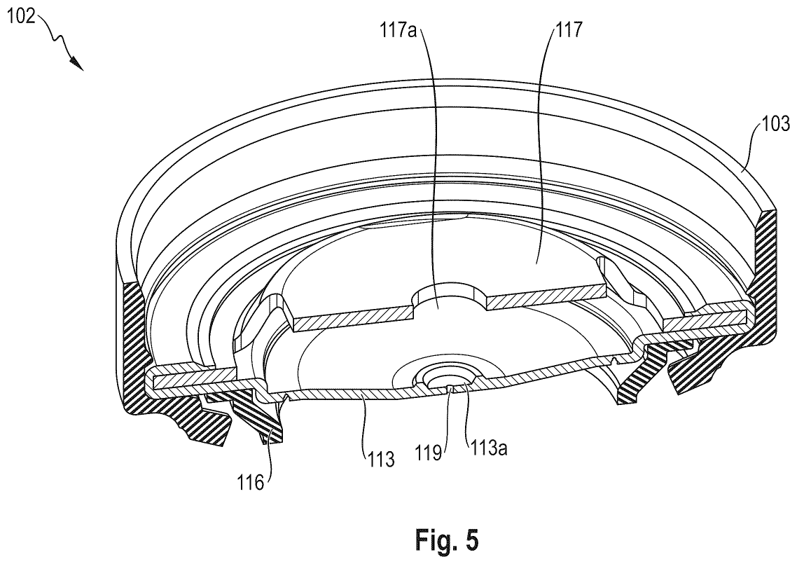

The lid assembly 102 shown in FIG. 5 comprises the pole cap 117, the metal disc 113, the annular seal 103, and the support ring 116. The metal disc 113 is in direct contact with the pole cap 117. The annular seal 103 is fitted onto the circular edge of the lid assembly 102. The edge of the lid assembly is in turn formed by the edge of the metal disc 113, which is folded back in a U-shape around the edge of the pole cap 117.

The pole cap 117 has a central hole 117a as an aperture. The center of the metal disc 113 is located below this hole. In the center of the metal disc 113 is the connecting region 113a, which is characterized by a lower material thickness in relation to the surrounding regions. The hole 119 is again located in the center of the connecting region 113a.

The lid assembly is shown in an unassembled state.

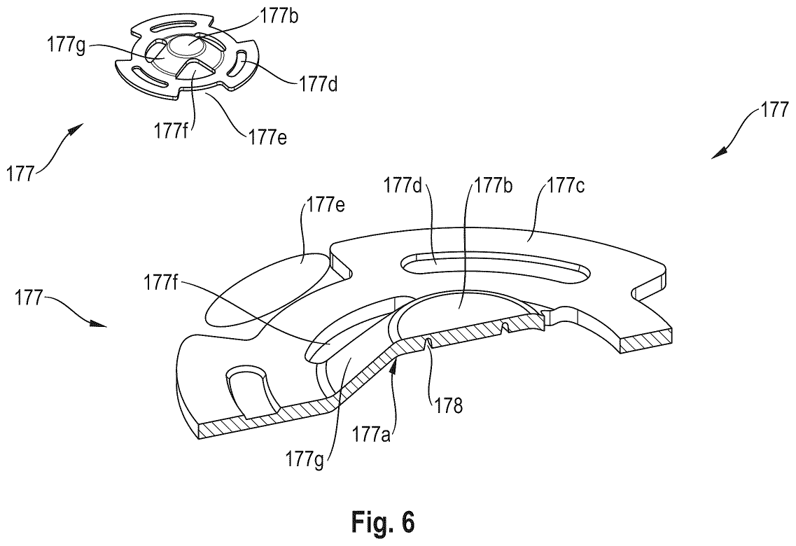

FIG. 6 shows a bridging sheet metal member 177 that can be used. This comprises the annular contact region 177c, which can be connected to the contact sheet metal member 112 by welding. The contact region 177c surrounds the bridging region 177a, which rises like a dome from the plane of the contact region 177c. The bridging region 177a is formed by three webs 177g which bridge an axial distance between the contact region 177c and the connecting region 177b. Three openings 177f are arranged between the webs, which can serve for the passage of electrolyte and for pressure equalization. The recesses 177e serve the same purpose.

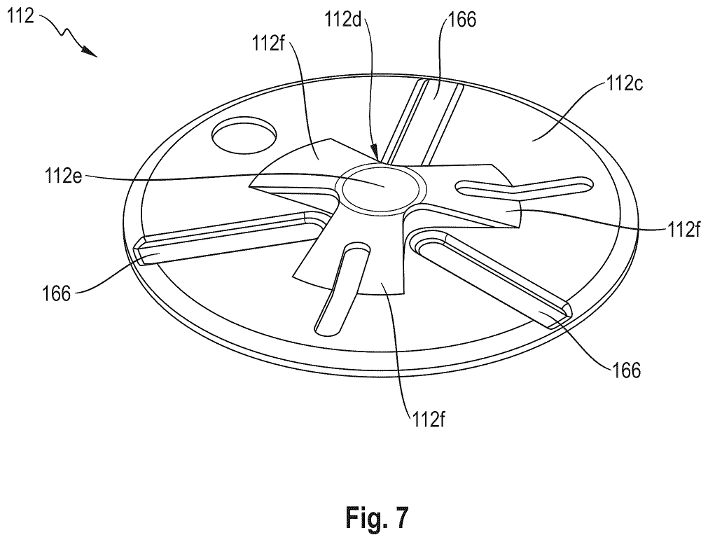

FIG. 7 shows a contact sheet metal member 112 which can be used. This comprises the disc-shaped contact region 112c which is intended for welding to the longitudinal edge 106a of the anode current collector 106 or the longitudinal edge 109a of the cathode current collector 109. Preferably, the contact region 112c extends essentially in a first plane. The bridging region 112d rises from the plane of the contact region 112c. The bridging region 112d comprises three webs 112f which connect the contact region 112c to the circular connecting region 112e, which has a flat surface. The connecting region 112c preferably extends in a second plane which is axially spaced from the plane of the contact region 112c.

In the contact region 112c, there are three beads 166 in a star-shaped arrangement. In the region of these beads 166, welding can take place with one of the longitudinal edges.

Bridging is often necessary in energy storage cells such as those shown in FIGS. 1 to 4 because components such as the electrode-separator assembly 104 cannot always be manufactured with exactly the same dimensions, for example with exactly the same height. Instead, process-related deviations occur which must be compensated for. The contact sheet metal member 112 enables tolerance compensation in the axial direction within a cell while simultaneously contacting the electrode-separator assembly or—more precisely—the longitudinal edge which protrudes from the end face of the assembly. In the embodiment shown, the bridging region 112d has a spring function and can act as a spring that presses downwards against the electrode-separator assembly and upwards against the lid. During the above-mentioned calibration, this spring effect in particular can have a compensating effect.

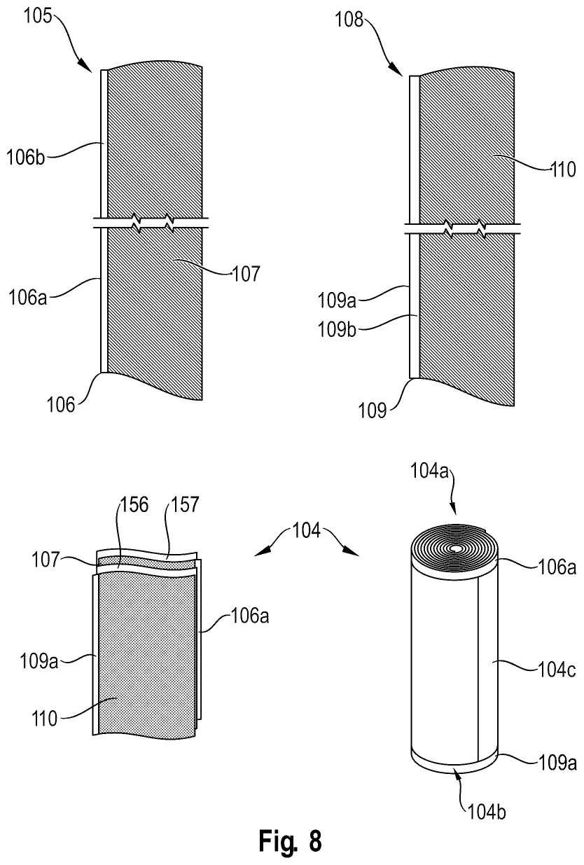

FIG. 8 illustrates the structure of an electrode-separator assembly 104, which may be part of an energy storage cell. The assembly 104 comprises the ribbon-shaped anode 105 with the ribbon-shaped anode current collector 106, which has a first longitudinal edge 106a and a second longitudinal edge parallel thereto. The anode current collector 106 is a foil made of copper or nickel. It comprises a ribbon-shaped main region loaded with a layer of negative electrode material 107 and a free edge strip 106b extending along its first longitudinal edge 106a and not loaded with the electrode material 107. Furthermore, the assembly 104 comprises the ribbon-shaped cathode 108 with the ribbon-shaped cathode current collector 109, which has a first longitudinal edge 109a and a second longitudinal edge parallel thereto. The cathode current collector 109 is an aluminum foil. It comprises a ribbon-shaped main region which is loaded with a layer of positive electrode material 110, and a free edge strip 109b which extends along its first longitudinal edge 109a and is not loaded with the electrode material 110. Both electrodes are shown individually in an unwound state.

The anode 105 and the cathode 108 are arranged offset from each other within the electrode-separator assembly 104 so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement is shown in the figure at the bottom left. The two ribbon-shaped separators 156 and 157 are also shown there, which separate the electrodes 105 and 108 from each other in the winding.

The figure at the bottom right shows the electrode-separator assembly 104 in wound form, as it can be used in an energy storage cell according to one of FIGS. 1 to 4. The electrode edges 106a and 109a protruding from the end faces 104a and 104b are clearly visible. The winding shell 104c is formed by a plastic film.

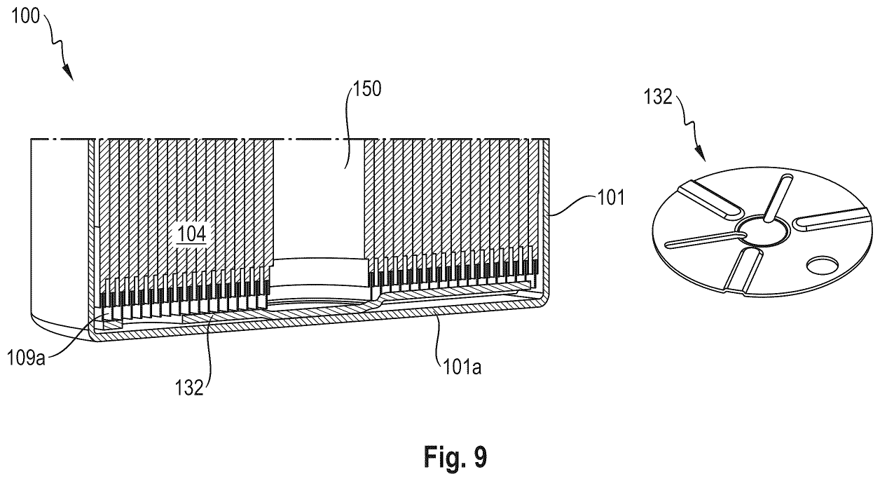

FIG. 9 shows the bottom region of a preferred embodiment of an energy storage cell 100. The electrode-separator assembly 104 is arranged in the housing cup 101. The contact sheet metal member 132 rests on the bottom 101a of the housing cup. Its bottom side is preferably connected to the bottom 101a by welding. The welding can be effected through the bottom 101a by means of a laser. Alternatively, for example, at least one welding electrode can be guided through the axial cavity 150 in the center of the electrode-separator assembly 104. A counter electrode can be pressed onto the outside of the bottom 101a. The top side of the contact sheet metal member 132 is in direct contact with the longitudinal edge 109a of an anode current collector. Preferably, the longitudinal edge 109a and the contact sheet metal member 132 are also connected by welding.

The contact sheet metal member 132 is shown separately. Like the contact sheet metal member 112, it has beads to improve contact with the longitudinal edge 109a. The slot-shaped apertures serve for degassing and for better distribution of electrolyte.

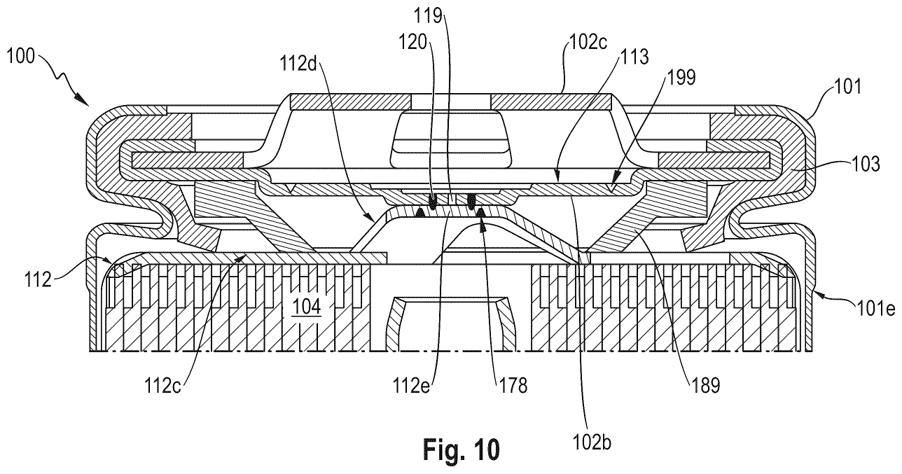

The embodiment of an energy storage cell shown in FIG. 10 differs from the energy storage cells shown in FIGS. 1 to 4 in that the contact sheet metal member 112 comprises the bridging region 112d. It further comprises a connecting region 112e which is connected to the inner side of the metal disc 113. The embodiment of the energy storage cell shown here therefore does not comprise a separate bridging sheet metal member which is welded onto a contact sheet metal member. The contact sheet metal member 112 itself fulfils the function of the bridging sheet metal member. This has obvious advantages. Electrical contact of the electrode-separator assembly is achieved from the pole cap, which can serve as a contact pole for tapping an electrical voltage of the energy storage cell, via only two metal parts, namely the metal disc 113 and the contact sheet metal member 112.

The contact sheet metal member 112 rests with the contact region 112c on the upper end face of the winding-shaped electrode-separator assembly 104 and is connected to the current collectors protruding from this end face, ideally by welding. The contact sheet metal member 112 can be formed in the same or a similar manner as the contact sheet metal member shown in FIG. 7. The contact region 112c surrounds the bridging region 112d, which rises dome-like from the plane of the contact region 112c and extends to the connecting region 112e, which in turn lies directly against the connecting region 113a of the metal disc 113. The contact sheet metal member 112 thus preferably comprises two regions (the contact region 112c and the connecting region 112e) in different planes, which are axially spaced apart from each other.

The metal disc 113 and the contact sheet metal member 112 are welded together in the connecting regions 112e and 113a. As in the case of the energy storage cell according to FIG. 1, the grooves 199 and 178 ensure a PRV and a CID function. The latter is supported by the support ring 189. This rests on the contact region 112c and is arranged between this and the edge region of the metal disc 113. If the center of the metal disc 113 bulges upward as a result of pressure occurring in the housing, the contact region 112c is fixed by the support ring 189 on the end face of the winding 104 and cannot be lifted. This ensures that the connecting region 112e can be blown out when sufficient pressure is applied, thereby interrupting the flow of current.

It is worth noting that the cell shown has a housing cup 101 which is characterised by an increased thickness in the closure section. Below the transition 101e, the housing cup is thinner than above. This is because, depending on the closure technology, higher mechanical strength is required in the closure section than in the central section in certain cases. Housing material can be saved there.

The metal disc 113 has a hole 119 in the connecting region 113a, through which pressure equalization between the interior of the housing and the housing environment can take place. The hole has a diameter of approximately 50 μm. As explained above, this can be helpful in the production of the welded connection, here in the form of weld seam 120, between the connecting regions. The hole 119 can be closed after the welded connection has been produced or during the production of the welded connection. But it may also remain open and be surrounded by the weld seam 120, as shown here.

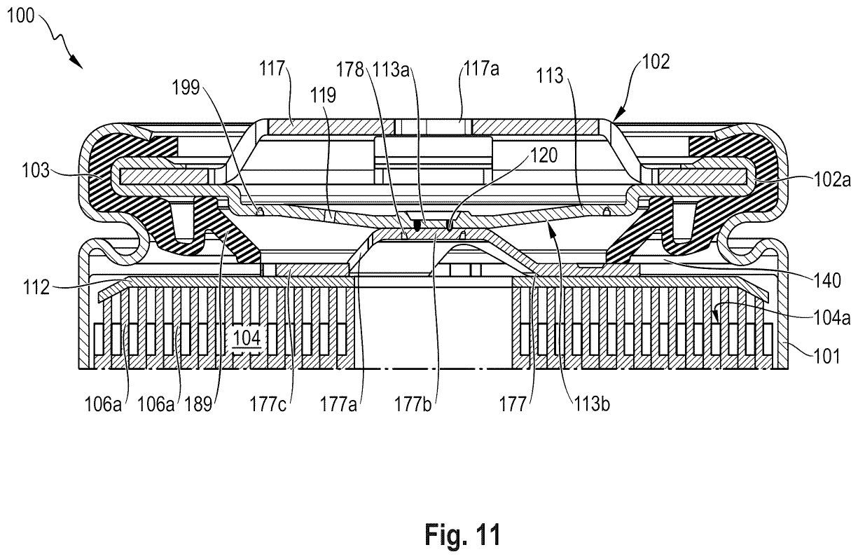

The energy storage cell 100 shown in FIG. 11 differs from that shown in FIG. 1 only in that the hole 119 is positioned off-center of metal disc 113. It is instead positioned laterally offset next to the connecting region 113a. It cannot therefore be closed when welding the connecting region 113a to the connecting region 112e or to the connecting region 177b. Its closure must be carried out in a separate step. For example, bonding, soldering or welding is possible, which can occur via one of the openings in the pole cap 117. The position of the openings in the pole cap 117 can be changed as required for this purpose.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of manufacturing an energy storage element, comprising:
a. providing an electrode-separator assembly with the sequence anode/separator/cathode, which has a first terminal end face and a second terminal end face;
b. applying a contact sheet metal member to the first terminal end face or the second terminal end face;
c. welding a bridging sheet metal member onto the contact sheet metal member or fixing a bridging sheet metal member to the contact sheet metal member by forming an alternative material-locking connection or a form-locking connection;
d. inserting the electrode-separator assembly into a housing part having a circular opening;
e. closing the circular opening of the housing part by a lid to form a closed housing, wherein the lid has a first side which, after closing, faces the interior of the housing, and a second side which faces the exterior; and
f. welding the lid to the contact sheet metal member or to the bridging sheet metal member;
wherein the lid has at least one hole which, when the lid is welded on, allows pressure equalization between the two sides of the lid.

2. The method according to claim 1, wherein the at least one hole is closed when the lid is welded on.

3. The method according to claim 1, wherein at least one of:
the lid is welded on using a laser; and/or
at least one hole is closed by the laser.

4. The method according to claim 1 wherein at least one of:
the closed housing encloses an interior space in which the electrode-separator assembly is arranged;
the lid comprises a metal disc with a circular edge, wherein the metal disc has an inner side that delimits the interior space; and/or
the metal disc comprises the at least one hole.

5. The method according to claim 4, wherein at least one of:
the contact sheet metal member comprises a connecting region in which it is connected to the inner side of the metal disc; and/or
the bridging sheet metal member comprises a connecting region in which it is connected to the inner side of the metal disc.

6. The method according to claim 5, wherein at least one of:
the metal disc comprises a connecting region in which it is welded to the connecting region of the contact sheet metal member or to the connecting region of the bridging sheet metal member; and/or
the connecting region comprises the at least one hole.

7. The method according to claim 5, wherein at least one of:
the lid is a lid assembly comprising, in addition to the metal disc, a pole cap which is in electrical contact with the metal disc;
the pole cap rests directly on the metal disc;
the pole cap and the metal disc enclose an intermediate space; and/or
the pole cap comprises at least one aperture through which the connecting region is accessible from outside the housing.

8. An energy storage element, comprising:
a. an electrode-separator assembly with the sequence anode/separator/cathode,
b. wherein the electrode-separator assembly is in the form of a cylindrical winding with a first terminal end face and a second terminal end face and a winding shell lying between them,
c. wherein the anode of the electrode-separator assembly comprises an anode current collector having a first longitudinal edge and a second longitudinal edge parallel thereto and a main region loaded with a layer of negative electrode material and a free edge strip extending along the first longitudinal edge and being not loaded with the negative electrode material,
d. wherein the cathode of the electrode-separator assembly comprises a cathode current collector having a first longitudinal edge and a second longitudinal edge parallel thereto and a main region loaded with a layer of positive electrode material and a free edge strip extending along the first longitudinal edge and being not loaded with the electrode material,
e. wherein the anode and the cathode are arranged within the electrode-separator assembly in such a way that the first longitudinal edge of the anode current collector protrudes from the first terminal end face and the first longitudinal edge of the cathode current collector protrudes from the second terminal end face of the electrode-separator assembly,
f. wherein the energy storage element comprises a contact sheet metal member that rests on the first longitudinal edge of the anode current collector and covers the first terminal end face or that rests on the first longitudinal edge of the cathode current collector and covers the second terminal end face,
g. wherein the energy storage element comprises an airtight and liquid-tight housing that comprises a metallic housing cup with a circular opening at its terminal end and a lid with a circular edge that closes the circular opening, and that encloses an interior space in which the electrode-separator assembly is arranged,
h. wherein the lid comprises a metal disc with a circular edge, the metal disc having an inner side which delimits the interior space and an opposite outer side,
i. wherein the contact sheet metal member comprises a bridging region which is connected in a connecting region to the inner side of the metal disc or a bridging sheet metal member is welded onto the contact sheet metal member, the bridging sheet metal member comprising a bridging region which is connected in a connecting region to the inner side of the metal disc,
j. wherein the metal disc comprises a connecting region in which it is connected by a weld to the connecting region or to the connecting region,
k. wherein, in the connecting region, the metal disc has a hole, a depression, and/or a reduction in thickness in a region of the weld.

9. A lid assembly for the energy storage element according to claim 8, the lid assembly comprising:
a metal disc; and
a pole cap, the pole cap being in electrical and direct mechanical contact with the metal disc,
wherein the pole cap rests directly on the metal disc,
wherein the pole cap and the metal disc enclose an intermediate space, wherein the pole cap comprises at least one aperture through which the connecting region is accessible from outside the housing,
wherein the lid assembly comprises a seal fitted onto its edge, and
wherein the connecting region comprises at least one hole.

10. The lid assembly according to claim 9, wherein the at least one hole is or comprises a hole with a minimum diameter of 0.01 mm and a maximum diameter of 1 mm.

11. The method according to claim 1 wherein, after step e., a formation of the energy storage element is carried out.
